(19) United States
(12) Patent Application Publication
(10) Pub. No.: US 2008/0141221 A1
(43) Pub. Date: Jun. 12, 2008

(54) Using recorder technology to find defects in software applications

(75) Inventors: Anna Benesovska, Seattle, WA (US); Douglas A. Anderson, Kirkland, WA (US); Dmitri A. Klementiev, Redmond, WA (US); Paul H. Donnelly, Newcastle, WA (US); Vincent Smith, Seattle, WA (US); Tenny Cho, Sammamish, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/636,036

(22) Filed: Dec. 8, 2006

(51) Int. Cl. G06F 9/44; G06F 9/04

(52) U.S. Cl. 717/124; 717/128

(57) ABSTRACT

Using recorder technology for finding defects in software applications by capturing software and/or user-driven events in a computing system. In one implementation, recorder technology is employed in a software defect reporting tool for reporting customer feedback related to software defects or bugs. The recorder can be utilized to capture events and defects for reporting such information to application vendors for defect resolution. A record file can be played back to reproduce the software defect and the steps leading up to the defect, and convert the information into a human readable file format. The recorder can also be used to create regressions scripts. When employed in a beta testing client reporting tool, customers are now able to record reproduce steps automatically, and ship the output file to the software vendor for more comprehensive reporting and hence, effective triage of the software defect.

### BACKGROUND

Computers are utilized at one level or another to monitor and control a wide variety of systems. For example, computers range in use from simple implementations such as home security systems that monitor closures of windows and doors to more complex applications that include industrial automation processes and life critical applications in hospitals.

The hardware aspect of computers is relatively straight forward in that the hardware performs according to the software designed to drive the device. However, software systems are another matter. For example, basic operating systems are no longer “basic” since the operating system for a desktop computer can include over one million lines of code that must run substantially bug-free. Moreover, a typical computing system will include many applications that should work together to provide a seamless and bug-free operation for the user.

In the context of software testing, for example, customers and vendor partners who evaluate pre-released versions of vendor software (e.g., operating systems) as part of a beta program can be provided with software for reporting defects back to the vendor. Technical beta customers are requested to submit information related to the steps to reproduce the defect manually. This can prove difficult to do as the users have to rely on recall and the ability to capture the exact sequence of steps leading to the defect. Moreover, the defect information and related steps have to be manually entered for understanding by vendor developers. Consequently, the difficulty in capturing the steps to reproduce in the bug report can result in excessive time and frustration further resulting in missed or incorrect steps which ultimately have a negative impact on the ability of vendor to debug and fix the software defect. Accordingly, software developers and testers should be provided more effective and efficient ways in which to report software problems.

In the context of customer satisfaction, companies are quickly realizing that the typical consumer is becoming more computer savvy, not only by experience but by necessity, and that the ease in which user interaction is facilitated with the device or software will be reflected in the corporate bottom line. Frustrated consumers will be unlikely to make future purchases. For example, the software/hardware vendors typically provide instructions for setup and configuration of the software/hardware that instruct the user how to reach a goal or troubleshoot the device. However, the instructions are generally in a text format that includes terms that can leave the user confused as to what is meant and requested to do. Accordingly, more effective and efficient ways for facilitating user interaction with hardware and software systems should be provided.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture implements recorder technology for finding defects in software applications by recording software and/or user-driven events in a computing system. The recorder can be utilized in any user interface (UI) based application, for example, as a more effective tool for capturing and storing information for later playback. In an alternative implementation, the recorder technology records only background processes not perceived by the user via the UI, but that lead up to occurrence of the defect.

In one specific implementation, a recorder is employed in or in combination with a software defect reporting tool for reporting feedback related to application defects or bugs. The recorder can be utilized to capture screenshots, for example, of a user interface that presents windows, application data and/or code, steps to reproduce a defect, and conversion of the information into a human readable file format. The recorder also can also be used to create regressions scripts for application testing.

When employed in combination with a beta testing client reporting tool, customers are able to effectively record steps that lead up to and include the defect and, send the output file to the software vendor for playback and for comprehensive processing and analysis. In one implementation, the user can manually initiate recording of the desired steps leading up to and including the defect. Manual recording can be performed on a step-by-step basis. In an alternative implementation, the architecture can facilitate automatic recording of the steps that lead up to and include the one or more defects. After occurrence of the defect, recording can then be stopped, if desired. Hence, more effective triage of the software defect can be accomplished.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates processing of application information.

FIG. 2 illustrates an alternative system for the processing of application information.

FIG. 3 illustrates a general system for beta testing and bug reporting in accordance with a specific application of the innovation.

FIG. 4 illustrates a system for multiple application events processing for defect recording and analysis.

FIG. 5 illustrates a diagram of application information that can be included in a defects record.

FIG. 6 illustrates a debugging system that processes record information for defect debugging.

FIG. 7 illustrates a system for parsing event and defect information from a record file.

FIG. 8 illustrates an alternative defect reporting system that includes a buffer for step recording.

FIG. 9 illustrates information that can be included as part of the record file that is sent to the debug server for replay and analysis.

FIG. 10 illustrates a method of utilizing recorder technology for application defects reporting.

FIG. 11 illustrates a method of reducing the record file size by eliminating unneeded recorded information.

FIG. 12 illustrates a method of recording events and defect information using an overwriting circular buffer.

FIG. 13 illustrates a method of configuring step count for recording events before a defect occurs using an overwriting circular buffer.

FIG. 14 illustrates a method of extending a record file with additional information.

FIG. 15 illustrates a method of including snapshots and file compression for record file processing.

FIG. 16 illustrates an exemplary UI for recorder management and configuration in accordance with the innovation.

FIG. 17 illustrates a block diagram of a computing system operable to execute the disclosed recording architecture.

FIG. 18 illustrates a schematic block diagram of an exemplary computing environment for defect recording and vendor web site processing in accordance with the innovation.

### DETAILED DESCRIPTION

The innovation implements recorder technology for finding defects in software applications by recording software and/or user-driven events in a computing system. The recorder finds particular applicability to a user interface (UI) based application, for example, as a more effective tool for capturing and storing information for later playback. The defect can include not only a bug in the software application itself, but also an error that can occur when interacting with other software applications. For example, the error can occur during installation of a first application, wherein an installation error occurs when the installation process causes interaction with the operating system.

The recorder technology can be employed in or in combination with a software defect reporting tool for manually and/or automatically generating a record file and reporting customer feedback related to software defects or bugs via the record file. The record file can be transmitted separately, in combination with, or as part of a report file of the reporting tool. Screenshots can be captured and the steps leading up to a software defect reproduced. When employed in a beta testing client reporting tool, customers are now able to record reproduce steps manually and/or automatically, and communicate the output file(s) (e.g., record file(s) and/or report file(s)) to the software vendor for more comprehensive reporting, and hence, more effective triage of the software defect. For example, in a manual implementation, the user can cause defect and the steps leading up to the defect to be recorded, after which the user can manually enter the associated information into a reporting form or template for reporting back to the vendor. This capability simplifies software defect reporting to the software vendor thereby significantly increasing the quality of defect reports since the report can now include a recording with complete and accurate steps to reproduce the defect. Vendor developers can now more quickly understand and repair the defect at hand. Additionally, the recorder technology can be used to generate test scripts that can be used for regression testing. Moreover, using recorder technology in a beta reporting tool, for example, facilitates the exposure of defects in software accessibility.

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

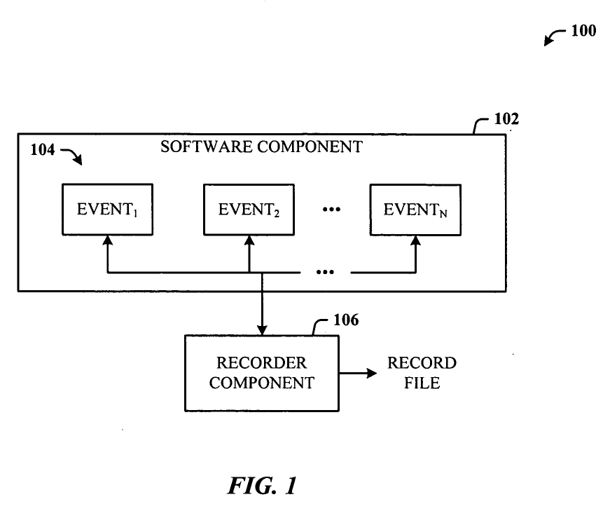

Referring initially to the drawings, FIG. 1 illustrates a system 100 that facilitates processing of application information. The system 100 can include a software component 102 for generating software-driven events 104 (denoted EVENT₁, EVENT₂, . . . , EVENT_{N}, where N is a positive integer) during execution of an application, and a recorder component 106 for recording (e.g., manually, automatically) execution of the events 104 and storing the recorded events as a record file (e.g., a record document or data) for playback. The events 104 can include a software defect (e.g., EVENT₂) that causes a stop in the normal software execution or exhibits an error during continued execution, for example.

The recorder component 106 facilitates generation of the record file that can include code-related events and processes, user interactions (e.g., keystrokes, mouse selections and actions), snapshots (or screenshots) of the user interface, as well as a continuously recorded video file of the user interface, and audio files, if desired. Accordingly, in a more expansive implementation, the system 100 can serve as a tool for generating tutorials, presentations, help files, and/or for memorializing application, data, and computing processes associated with industrial automation systems, for example.

In a more specific application, the system 100 can be employed as a component of a beta testing and debug reporting system (e.g., a client or server). The recorder component 106 employs recorder technology for manually and/or automatically generating the record file of defect information and reporting customer feedback related to the software defects or bugs. The recorder technology enables manual and/or automatic recording of system, application, and the user activities prior to and including the defect(s). In an alternative embodiment, recording can include events or steps that occur after the first defect, and which can include a second defect. This provides a comprehensive and flexible capability for accurately and efficiently recording a substantial portion of the information desired by application developers to effectively resolve program bugs or defects. The code-related events can be saved in chronological order according to the time of the defect event, and as one or more data parts associated with the events.

The one or more data parts and recording data can be packaged as a single compressed file (e.g., an RSS file) and sent for reporting and replay processing. RSS (really simple syndication) can be a lightweight XML (extensible markup language) or a binary format designed for sharing information and other content. Alternatively, or in combination therewith, the data parts are in a format that can be automatically inserted into a bug report template thereby relieving the user of having to manually enter the event information into the report template. The bug report and record file can then be sent to a reporting site for playback for more detailed debug analysis and correction of the reported defect in the application.

Screenshots can be captured and the steps leading up to a software defect reproduced. In a manual implementation, the user can initiate recording on a step-by-step basis or continuously up to and including occurrence of the defect. This can further include other system and software information proximate to the occurrence of the defect. When employed in a beta testing client reporting tool, customers are able to record reproduce steps manually (or in an alternative embodiment, automatically), and send the output file(s) (e.g., a record file, report file) to the software vendor for more comprehensive reporting, and hence, more effective triage of the software defect. This capability simplifies software defect reporting to the software vendor thereby significantly increasing the quality of defect reports, since the report can now include a recording with complete and accurate steps to reproduce the defect. Vendor developers can now more quickly and effectively understand and repair the defect at hand. Additionally, the recorder technology can be used to generate test scripts that can be used for regression testing. Moreover, using recorder technology in a beta reporting tool, for example, facilitates the exposure of defects in software accessibility.

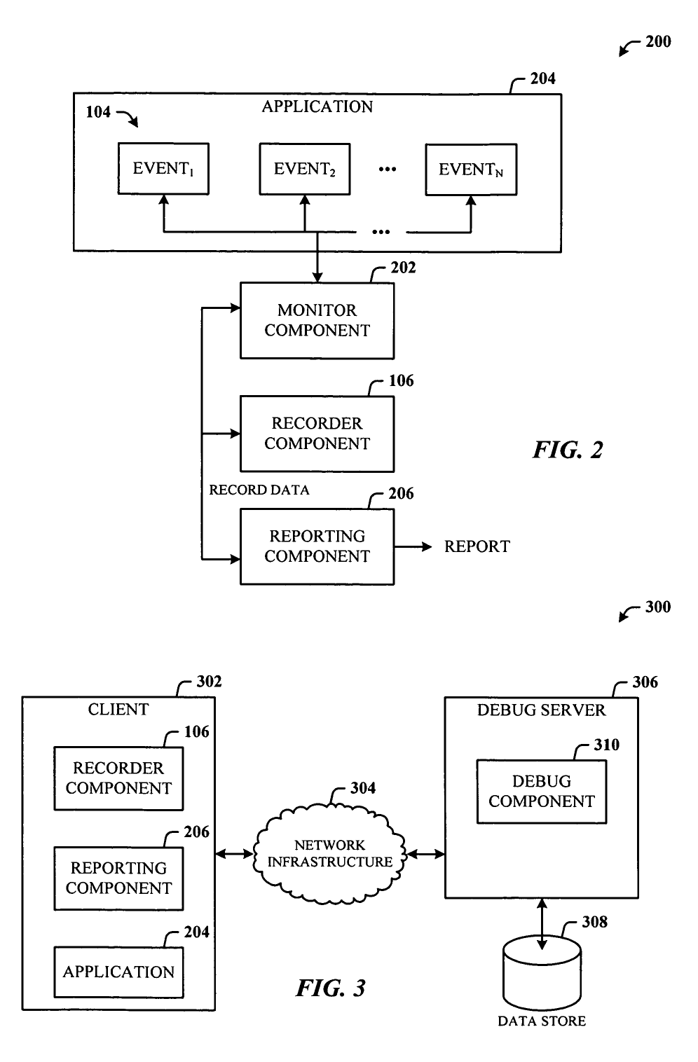

FIG. 2 illustrates an alternative system 200 for the processing of application information. The system facilitates automatic and continuous monitoring, buffering and recording of defect (or error) information. A trigger (e.g., a defect that causes an abnormal stop or a defect that causes a continuous error) initiates the recording process, thereby capturing the defect information and other software/hardware information. The system 200 includes a monitor component 202 for sensing the software-driven events 104 (e.g., a defect and steps leading up to the defect) during execution of an application 204 (e.g., the software component 102 of FIG. 1), and the recorder component 106 for automatically recording execution of the events 104 in the application 204 and storing the recorded events as a record file of record data for playback.

The system 200 can also include a reporting component 206 for outputting a report to a remote location (e.g., debug server) for processing and analysis of the included information. Here, the report can include the record data created and stored via the recorder component 106. Information other than the record data can be included in the report file. For example, the report can include hardware information associated with the particular client device (e.g., portable computer, cell phone, desktop computer) on which the application 204 (e.g., a client application) resides and executes.

FIG. 3 illustrates a general system 300 for beta testing and bug reporting in accordance with a specific application of the innovation. The system 300 includes a client system 302 having the application 204 under test and from which a defect can occur. Here, the client 302 includes the recorder component 106 and reporting component 206. The client 302 communicates over a network infrastructure 304 to a vendor debug server 306 (e.g., an accessible web server) that serves as a location for sending defect reports (and recordings) for a number of different vendor applications. The reports can be stored on a server data store 308 for later retrieval and processing. The reports can also be stored in faster non-volatile memory, since application failure due to the defect can cause loss of the data in a volatile memory. The server 306 can include a debug component 310 for retrieving at least the record file for processing by, for example, replaying the record file to determine the events surrounding the application defect. Where the data parts of the record file have been inserted into a report template and sent to the server 306 in the report file, the report file can be processed to parse out the data parts for the events information, for example.

In an alternative implementation, the steps and defects information can be extracted from the record file to automatically populate a bug tracking database of the data store 308 so that files do not need to be played back.

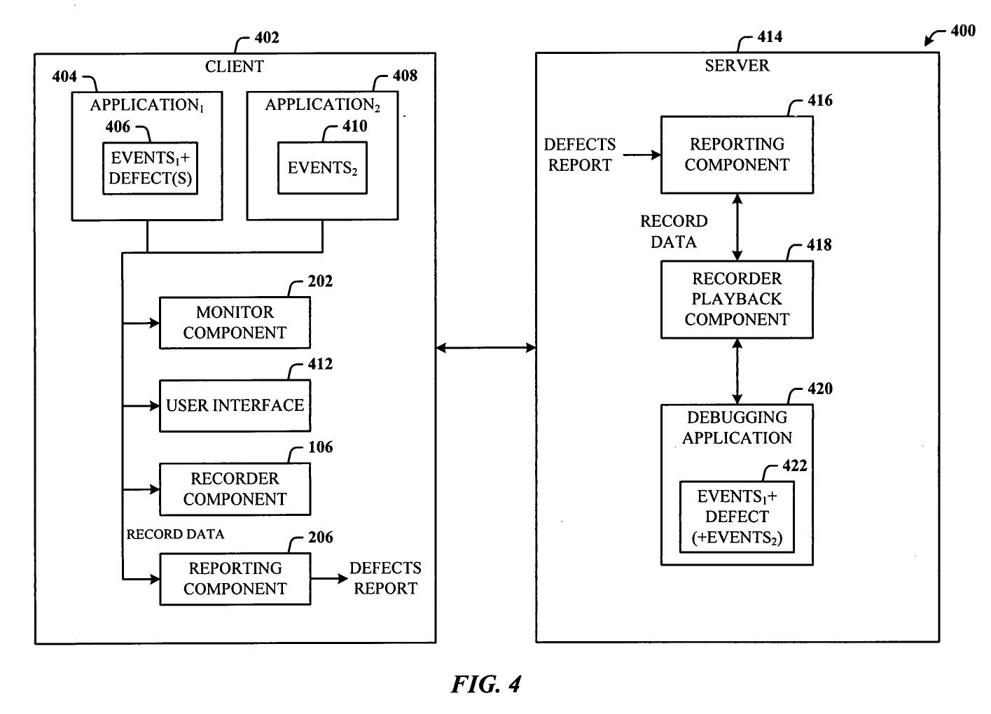

FIG. 4 illustrates a system 400 for multiple application events processing for defect recording and analysis. Here, a client system 402 includes two applications: a first application (APPLICATION₁) 404 (similar to application 204) that when launched exhibits events (EVENTS₁) and one or more defects (DEFECT) 406, and a second application (APPLICATION₂) 408 that generates one or more events (EVENTS₂) 410 associated with operation, and when the first application 404 is operating. In other words, the first and second applications (404 and 408) can interact such that one or more of the events 410 in the second application 408 should be reviewed as potentially part of the cause of the defect in the first application 404.

The client system 402 can, optionally, include the monitor component 202, recorder component 106 and the reporting component 206, for sensing the application events and defect(s) (406 and 410), recording the events and defect(s) in a record file, and generating a defects report. The client 402 can also include, optionally, a user interface (UI) 412 for user interaction with at least functionality associated with the monitor component 202 and recorder component 106 for configuration, triggering and creation of the record data (e.g., one or more record files).

For example, the recorder component 106 can include a recorder client that installs recorder functionality as add-ons into the first application 404 for access by the user. Thus, when a defect (e.g., in the first application 404) is sensed and shown via the UI 412, the user can restart the application 404 at a suitable point (e.g., the beginning, interim operation), start the recorder via the application interface, and initiate the first application 404 to reproduce the steps for recording by the recorder component 106. Selectively or automatically, the recorder component 106 can record the events 410 of the second application 408 for playback as a separate file for the second application 408 or as part of the record file of the first application 404. The defects report of the reporting component 206 can include one or both of the record files for the first and second applications (404 or/and 408) and report data (e.g., client system 402 information, hardware configuration, software updates information).

The defects report is received at a vendor server 414 and can be processed into a server reporting component 416 for parsing of the defects report into its constituent components, for example, the recorder file(s) and report file. The record data can be sent to a recorder payback component 418 for data playback by a user to get a better understanding of the defect and the events (e.g., EVENTS₁ and/or EVENTS₂) associated therewith. Playback can be invoked via a debugging application 420 that responds to information received from the playback component 418 to control the debugging application 420 to reproduce events and defect 422 (e.g., EVENTS₁+DEFECT (and EVENTS₂)) for user viewing.

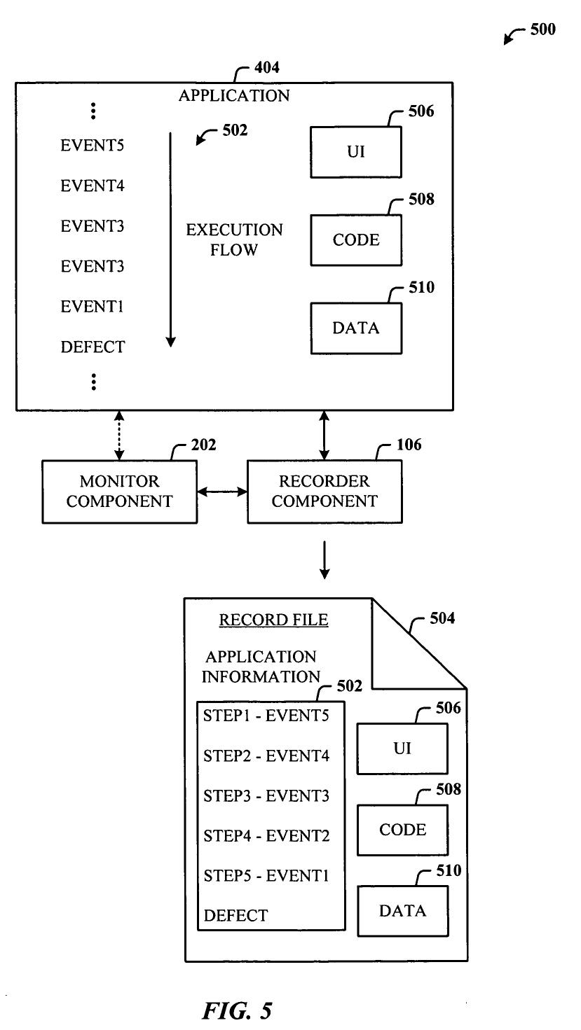

FIG. 5 illustrates a diagram 500 of application information that can be included in a defects record file. The application 404 is depicted as generating events and defect information 502 that includes five events (denoted EVENTS1-5) before a defect is generated. Accordingly, it is desired to record this information 502 in a record file 504 for transmission to the vendor for playback and debugging. The application 404 can also include UI information 506 (e.g., settings), code 508 (e.g., event and defect related) and data 510 (e.g., data results of the events and/or defect), for example, that can be useful in debugging the defect.

The monitor component 202 can be optionally provided to monitor this information of the application 404, and send the events and defect information 502 to the recorder component 106 during a recording session. In another implementation, the recorder component 106 records the information directly (bypassing the monitor component 202). This can be manually initiated by the user or automatically according to recorder component settings.

Once recorded, the recorder component 106 outputs the record file 504 for processing. The record file 504 is shown to include at least the events and defect information 502 for playback as a series of steps (STEP1-5). Additionally, the record file 504 can optionally include the application information such as the UI information 506, code information 508, and/or data information 510.

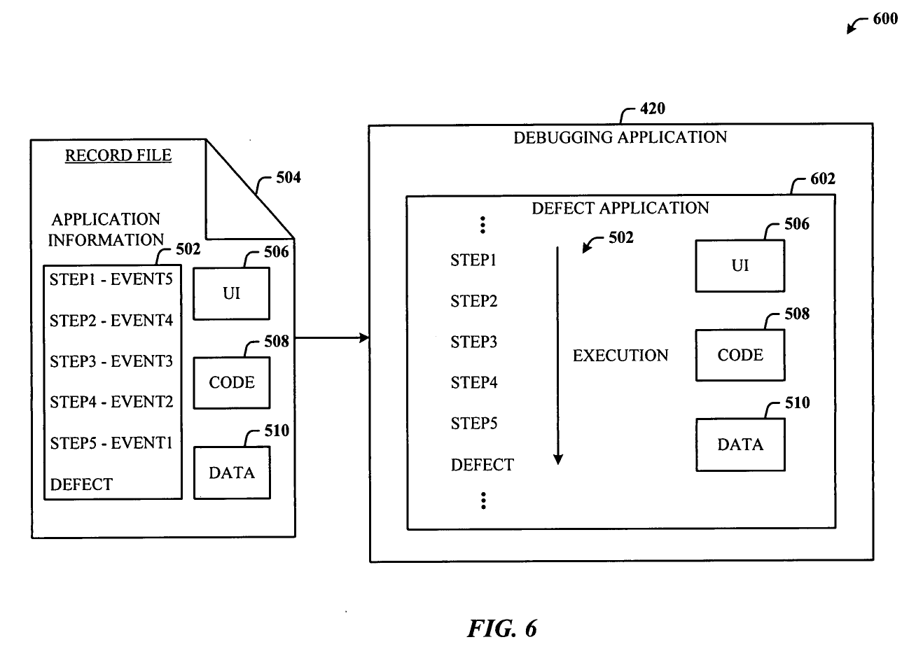

FIG. 6 illustrates a debugging system 600 that processes recorded information for defect debugging. The record file 504, which includes at least the recorded events and defect information 502, is sent to the debugging application 420. In this scenario, the debugging application 420 can include the capability to launch an associated defect application 602 for playback of the record file 504 and associated steps to recreate the defect and view visual information as part of the record file 504. For example, the defect application 602 can process the UI information 506 for replaying the user interface screenshots and/or video information that were being presented when the corresponding step (e.g., STEP 3) and associated event (e.g., EVENT3) was being executed.

Similarly, code 508 can be executed and presented as part of the replay process. In one example, the associated code is simply presented as the steps are executed. In another example, the code is executed as part of playback of the reproduce steps. As shown, the application data 510 can also be presented in direct comparison with data that has been created when the application has been properly debugged for the current defect.

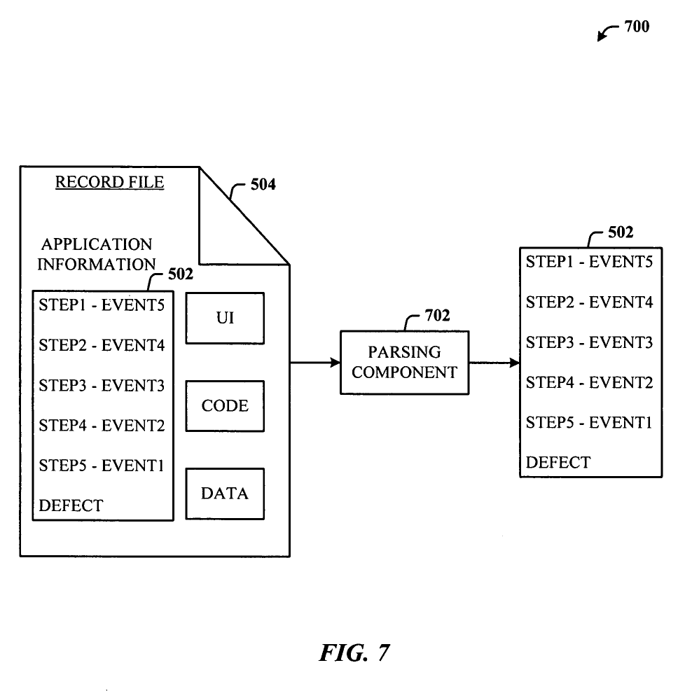

FIG. 7 illustrates a system 700 for parsing event and defect information from a record file. The system 700 can include a parsing component 702 for extracting only the event (or step) and defect information 502 from the record file 504. The information 502 can then be used in any desired manner such as consolidation with other defects information as an overall log, for example.

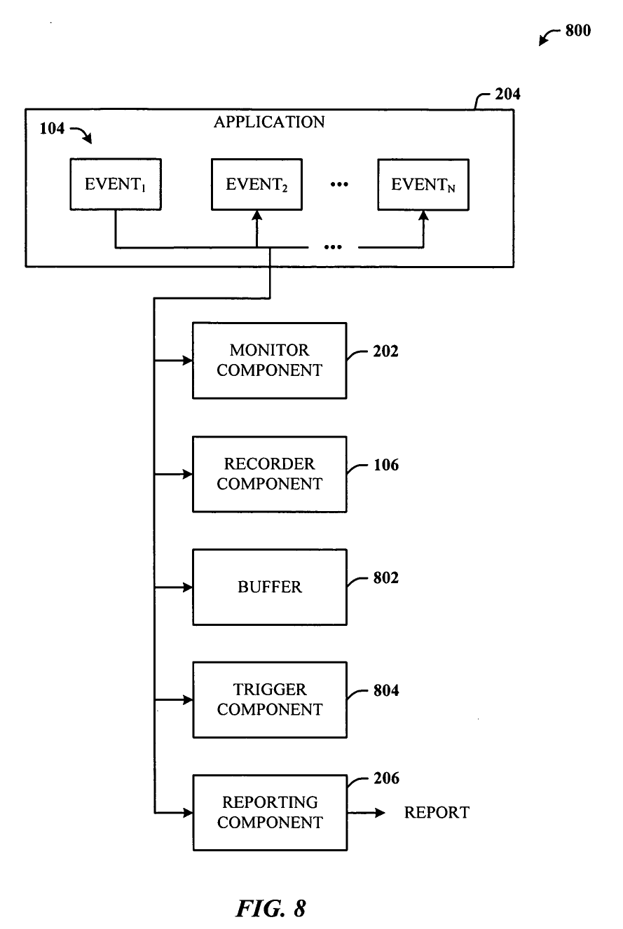

FIG. 8 illustrates an alternative defect reporting system 800 that includes a buffer for step recording. The system 800 can include the monitor component 202, recorder component 106, and reporting component 206 for sensing, recording and sending a report file (that includes record information). In this implementation, the system 800 includes a buffer 802 for storing a record of the last N steps of event information leading up to the defect, and the defect. In one scenario previously described, once the user encounters an application defect, the user can restart at a point in the application prior to the defect. For example, if the user was initiating a copy function in an open document when the defect occurred, the user can start recording at this point to capture the defect and associated defect information (e.g., steps leading up to the defect occurrence). The recorder component 106 can then facilitate capture of UI objects, artifacts, etc., and/or underlying code steps being executed. This can be up to the discretion of the user as to how far to go back before the point at which the defect occurred.

A trigger component 804 is provided to facilitate manual and/or automatic triggering of recorder component 106 activation. For example, if the user chooses to go back approximately ten steps before occurrence of the defect, once at that point, the trigger component 804 can receive user input (e.g., UI button selection) that enables the recorder component 106 to begin recording all desired information (e.g., snapshots, audio, video, code). The user can also choose to pick some arbitrary point before occurrence of the defect to initiate (or trigger) the trigger component 804 for recording information.

In another implementation, the buffer 802 is a circular buffer such that recording occurs continuously, thereby writing events information into the buffer 802 continuously. When a defect occurs or is sensed, the user or the system can trigger the trigger component 804 to stop the overwrite process, thus, capturing the events and defect information in the buffer 802 for download and storage. For example, if the buffer 802 is 1 MB (megabytes) in size, the system 800 can be designed so that the user can configure a percentage of how much of the buffer should be used for continual overwriting. If the user chooses to configure fifty percent of the buffer 802 for overwriting, then the record file will include about 500 KB (kilobytes) of events and defect information. It is to be understood that the user can approximate the time required for an event to occur. Based on this information, the user can then approximate how many steps (or events) can be captured (or recorded) by selecting the appropriate buffer size for overwriting.

In the automatic scenario, when the application itself, or the monitor component 202, senses a defect, abnormal halt, or stop, for example, this can be used as the trigger to automatically stop overwriting in the buffer 802, thereby capturing events and defect information based on the configured size of the buffer 802.

In another example, the user can configure the trigger component 804 to only stop buffer overwriting after the defect is detected (e.g., when a second defect is detected after a first defect has been encountered). Thus, the user can record events leading up to the defect and after the defect, should the application still run. In other words, it is within contemplation of the innovation that the user can configure a post-trigger setting for ninety percent pre-trigger buffering and ten percent of the buffer for post-defect recording, for example. Other percentages can be provided to the user for selection, if desired. Accordingly, it is to be appreciated that given such recording capability, the user is given wide flexibility in recording defect and events information for resolving application defects or bugs.

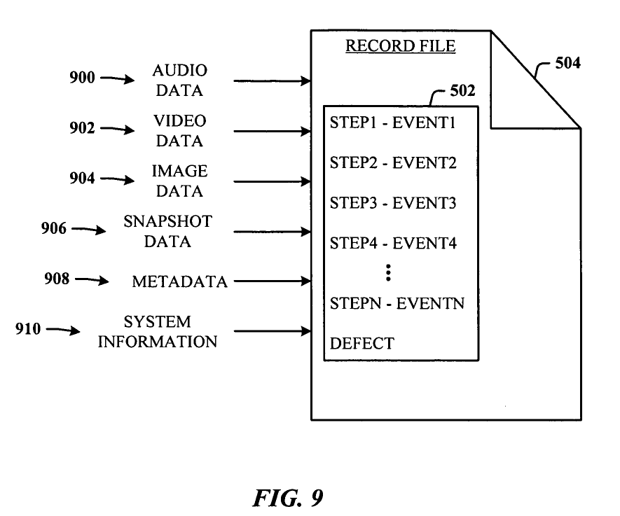

FIG. 9 illustrates information that can be included as part of the record file that is sent to the debug server for replay and analysis. The record file 504 is shown to include at least the events and defect information 502 (denoted EVENT1, . . . , EVENTN, where N is a positive integer, and DEFECT). Additionally, other information that can be recorded as part of the record file 504 can include the following: audio data 900, where the user provides voice data, for example, to accompany the steps taken; video data 902 for recording a video of the whole process pre- and post-defect; image data 904, such as screenshot data of the user interface pre- and post-defect; snapshot data 906, which can include capture of a variety of data (e.g., screenshot, video, audio, code, application data) at a point in time; metadata 908, such as temporal data, application type, application version, user information, etc.; and, system information 910, such as hardware, operating system, processor, etc.

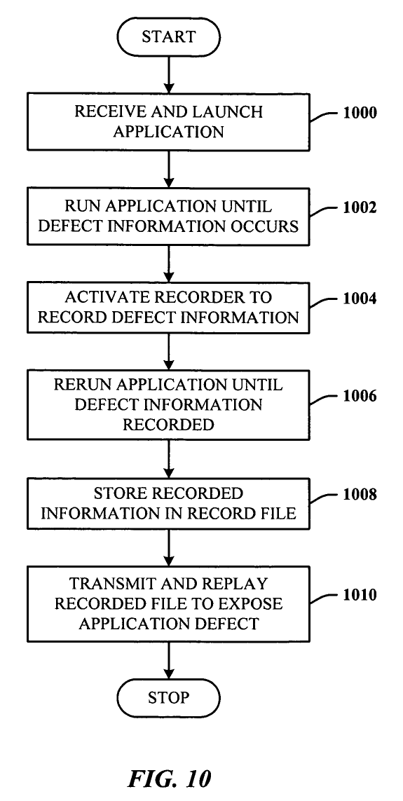

FIG. 10 illustrates a method of utilizing recorder technology for application defects reporting. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 1000, an application is received and launched. This can be a beta quality application sent to partners for testing, and/or for any application that is currently exhibiting a defect or bug. At 1002, the application is run until the defect information occurs. At 1004, the user activates the recorder to record the defect information. At 1006, the user reruns the application to recreate and record the defect information. At 1008, the recorded defect information is saved in a record file (e.g., RSS file). At 1010, the record file is transmitted for replay and debugging analysis to reproduce the defect information to resolve the application defect.

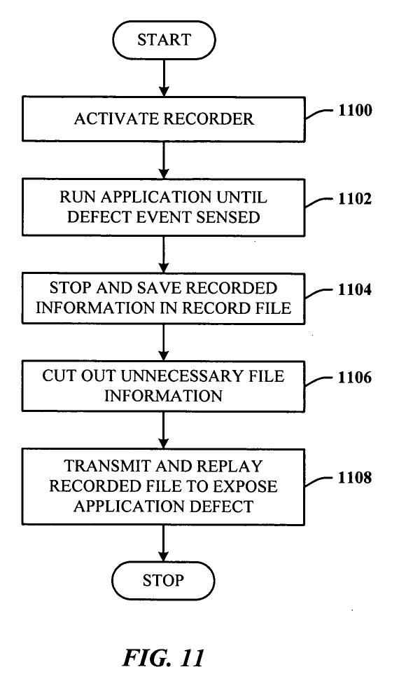

FIG. 11 illustrates a method of reducing the record file size by eliminating unneeded recorded information. At 1100, the recorder is activated after the defect has been detected. At 1102, the user reruns the application until the defect event is sensed again. At 1104, the record operation is stopped and the record file stored. At 1106, the unneeded information in the record file is removed prior to sending the file to the software vendor for debug processing. In one example, this can be facilitated by comparing timestamp information associated with the desired steps and deleting information prior to the time associated with the first step (or furthest in time from the time the defect occurred). At 1108, the record file is transmitted and replayed to expose the application defect.

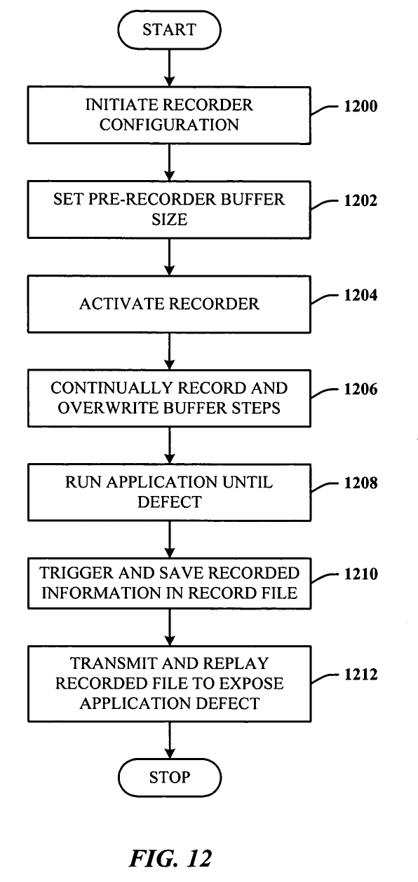

FIG. 12 illustrates a method of recording events and defect information using an overwriting circular buffer. At 1200, the user initiates the recorder configuration interface. At 1202, the user sets the pre-trigger buffer size. For example, the user can allocate percentages of buffer storage for pre-trigger and post-trigger recording. At 1204, the recorded is activated. At 1206, the recorder operates to continually record and overwrite previously loaded buffer locations with events (or steps). At 1208, the user launches the application until a defect is sensed. At 1210, the buffer is triggered to stop recording (and hence, overwriting buffer locations) after the defect information is written into the buffer. At 1212, the record file is transmitted and replayed for application debugging.

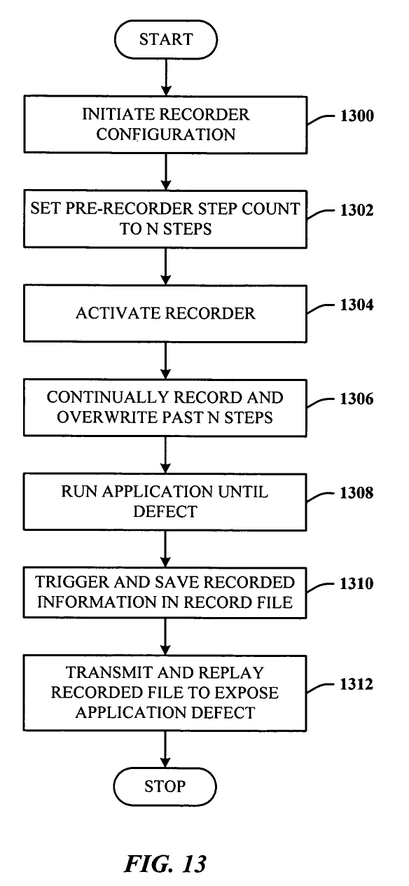

FIG. 13 illustrates a method of configuring a step count for recording events before a defect occurs using an overwriting circular buffer. For example, the user can estimate the number of steps to record before the defect appeared, move back that number of steps in application operation, initiate the recorder, and record until the defect occurs again. At 1300, the user initiates recorder configuration. At 1302, the user configures a pre-trigger step count setting (up to N steps, where N is a positive integer) for a number of steps to record before the defect occurred. At 1304, the recorder is activated. At 1306, the recorder begins to continually record events (or steps) and overwrite buffer locations until a trigger is detected. At 1308, the application is run until the defect occurs. At 1310, a trigger is sent in response to which the recorder writes the defect information into the buffer and stops writing further information into the buffer. At 1312, the record file is then stored, transmitted and replayed for application debugging.

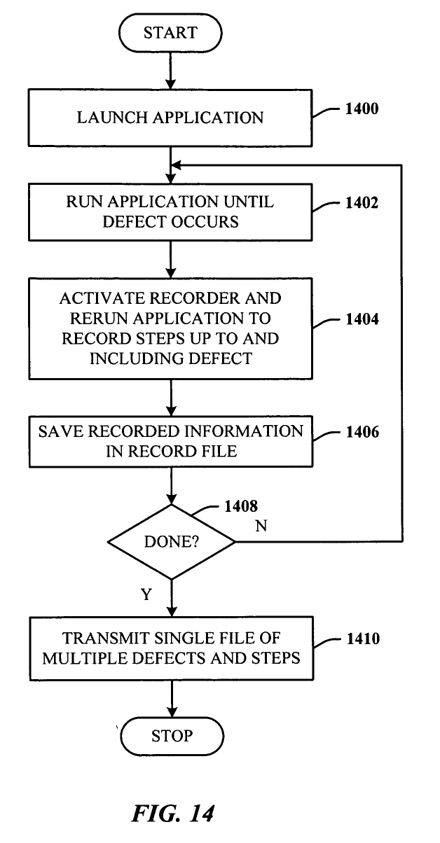

FIG. 14 illustrates a method of extending a record file with additional information. At 1400, the application is launched. At 1402, the application is run until a defect occurs. At 1404, the recorder is activated and the application rerun to record steps up to and including the defect. At 1406, the recorded information is saved in a record file. At 1408, a check is made to determine if a defect recording is complete. In other words, the user can record a first defect, and then come back to address another found defect, and append (or add to) the exiting record file with the second defect information. If, at 1408, the user is not done, flow is to 1402 to again, run the application until another defect is found, and then repeat the recording process by saving second defect information in the record file. This can continue until the user chooses to stop, or a file size limitation has been exceeded, for example. Once done, flow is from 1408 to 1410, to transmit a single file of multiple defects and related events information for debugging replay and analysis.

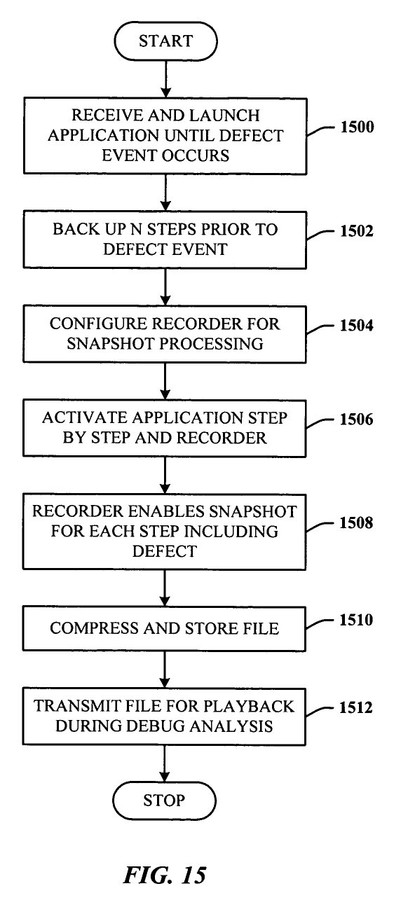

FIG. 15 illustrates a method of including snapshots and file compression for record file processing. At 1500, an application is received and launched until a defect occurs. At 1502, the user then backs up the desired number of steps prior to initiating the recording process. At 1504, the user configures the recorder for snapshot processing. That is, according to each step or designated steps, the record will automatically take a snapshot of selected information (e.g., screenshot, event information, code, data, and time). At 1506, the application is controlled to process forward step by step. At 1508, the recorder takes a snapshot of the selected information (e.g., a screenshot of the UI) at each step, including the defect. At 1510, the recorder is stopped and the record file compressed and stored. At 1512, the file is transmitted for playback during debug analysis.

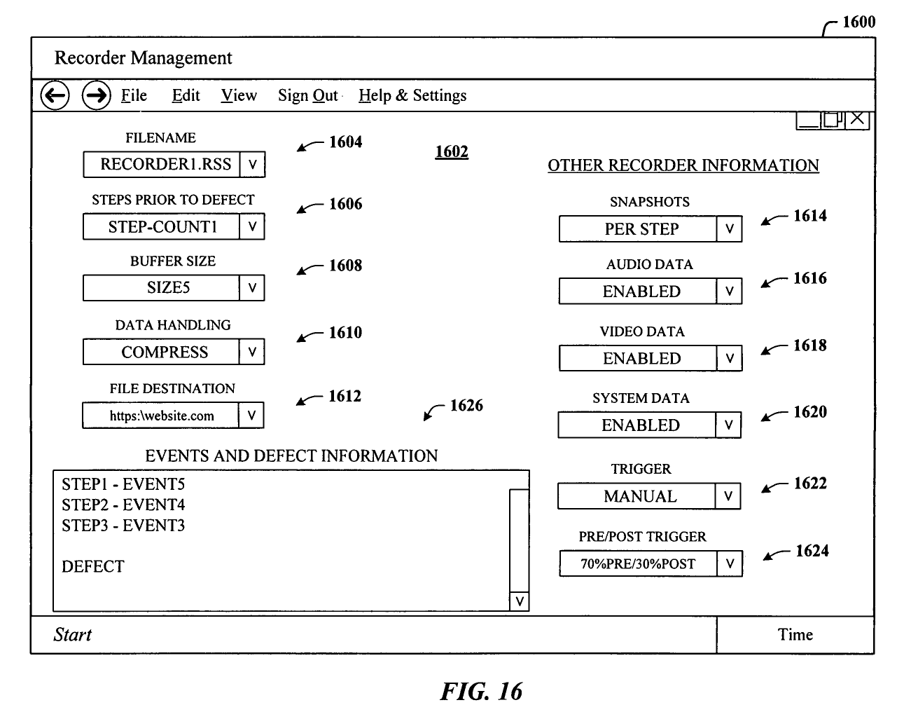

FIG. 16 illustrates an exemplary UI 1600 for recorder management and configuration in accordance with the innovation. The UI 1600 include a configurable work surface 1602 where the user can select settings to expose for configuration. For example, here, the UI 1600 allows the user create a filename 1604 of the record file. The user can also configure the steps to record prior to the defect, at 1606. At 1608, the user can set the buffer size allocation for recording step and defects information, and other information (e.g., snapshots, audio information) as well. At 1610, the user can select file compression when saving and/or sending the file. At 1612, the user can designate the location to which the file should be sent, once recording has completed. This can be a secure website, using “https:\”, for example. Transmission of the recorder file can be manual or automatic.

Other recording information can be selected for inclusion in the record file. For example, at 1614, snapshot information can be selected for recording, and then, per step. At 1616, audio data can be enabled for recording as part of the record file. At 1618, video data can also be included. This can be more than the visual information provided by the recording operation itself. At 1620, system data can be selected for inclusion.

At 1622, additional triggering selections can be made. Here, the user can select between manual and automatic triggering of the recorder operation. At 1624, the user can select pre-trigger buffer allocation and post-trigger buffer allocation. Here, based on the selected buffer size at 1608, the user can select that 70% is allocated to pre-trigger (or pre-defect) data (e.g., step) recording and 30% as post-trigger data (e.g., step) recording.

The UI 1600 can also include a realtime presentation of the selected step information and defect information in an events and defect information window 1626. This can be presented in realtime as the recording is occurring. This can also be employed as a playback feature at the client prior to sending the record file to the debug web site to ensure that the desired defect information was recorded for testing and debug processing.

While certain ways of displaying information to users are shown and described with respect to certain figures as screenshots, those skilled in the relevant art will recognize that various other alternatives can be employed. The terms “screen,” “screenshot”, “webpage,” “document”, and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

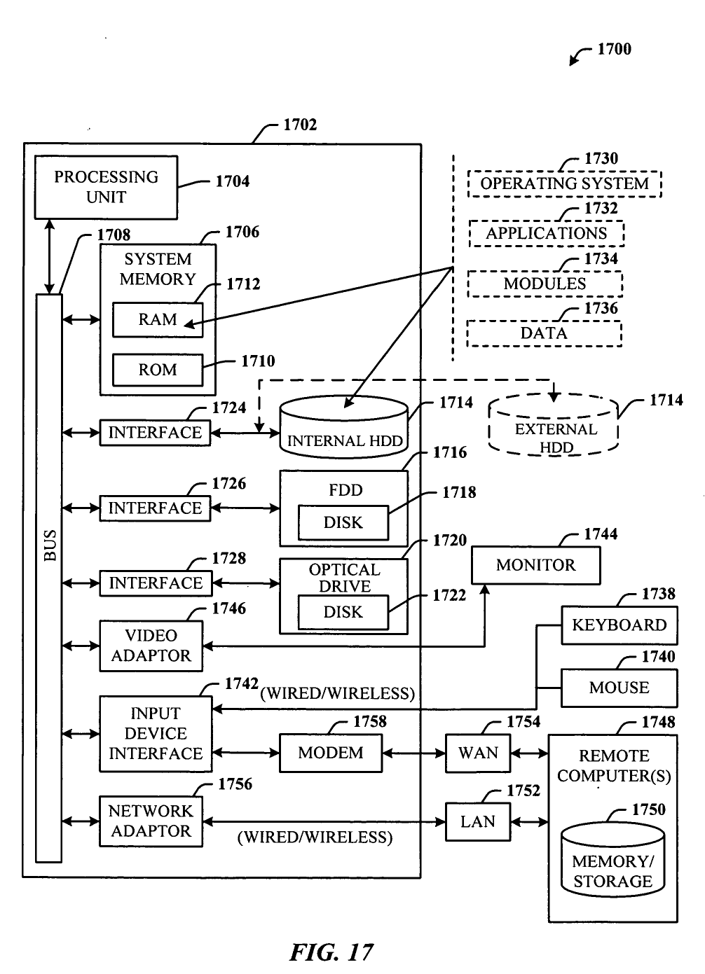

Referring now to FIG. 17, there is illustrated a block diagram of a computing system 1700 operable to execute the disclosed recording architecture. In order to provide additional context for various aspects thereof, FIG. 17 and the following discussion are intended to provide a brief, general description of a suitable computing system 1700 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 17, the exemplary computing system 1700 for implementing various aspects includes a computer 1702, the computer 1702 including a processing unit 1704, a system memory 1706 and a system bus 1708. The system bus 1708 provides an interface for system components including, but not limited to, the system memory 1706 to the processing unit 1704. The processing unit 1704 can be any of various commercially available processors. Dual microprocessors and other multi-processor architectures may also be employed as the processing unit 1704.

The system bus 1708 can be any of several types of bus structure that may further interconnect to a memory bus (with or without a memory controller), a peripheral bus, and a local bus using any of a variety of commercially available bus architectures. The system memory 1706 includes read-only memory (ROM) 1710 and random access memory (RAM) 1712. A basic input/output system (BIOS) is stored in a non-volatile memory 1710 such as ROM, EPROM, EEPROM, which BIOS contains the basic routines that help to transfer information between elements within the computer 1702, such as during start-up. The RAM 1712 can also include a high-speed RAM such as static RAM for caching data.

The computer 1702 further includes an internal hard disk drive (HDD) 1714 (e.g., EIDE, SATA), which internal hard disk drive 1714 may also be configured for external use in a suitable chassis (not shown), a magnetic floppy disk drive (FDD) 1716, (e.g., to read from or write to a removable diskette 1718) and an optical disk drive 1720, (e.g., reading a CD-ROM disk 1722 or, to read from or write to other high capacity optical media such as the DVD). The hard disk drive 1714, magnetic disk drive 1716 and optical disk drive 1720 can be connected to the system bus 1708 by a hard disk drive interface 1724, a magnetic disk drive interface 1726 and an optical drive interface 1728, respectively. The interface 1724 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1712, including an operating system 1730, one or more application programs 1732, other program modules 1734 and program data 1736. All or portions of the operating system, applications, modules, and/or data can also be cached in the RAM 1712. It is to be appreciated that the innovation can be implemented with various commercially available operating systems or combinations of operating systems.

The program modules 1734, for example, can include the components described herein for monitoring, recording, reporting, buffering, triggering, parsing, and storing application events/defect information, playback, and so on. Additionally, recording architecture described herein can be employed in the system 1702, which can be a cell phone, portable computer, desktop computer, and so on.

A user can enter commands and information into the computer 1702 through one or more wired/wireless input devices, for example, a keyboard 1738 and a pointing device, such as a mouse 1740. Other input devices (not shown) may include a microphone, an IR remote control, a joystick, a game pad, a stylus pen, touch screen, or the like. These and other input devices are often connected to the processing unit 1704 through an input device interface 1742 that is coupled to the system bus 1708, but can be connected by other interfaces, such as a parallel port, an IEEE 1394 serial port, a game port, a USB port, an IR interface, etc.

A monitor 1744 or other type of display device is also connected to the system bus 1708 via an interface, such as a video adapter 1746. In addition to the monitor 1744, a computer typically includes other peripheral output devices (not shown), such as speakers, printers, etc.

The computer 1702 may operate in a networked environment using logical connections via wired and/or wireless communications to one or more remote computers, such as a remote computer(s) 1748. The remote computer(s) 1748 can be a workstation, a server computer, a router, a personal computer, portable computer, microprocessor-based entertainment appliance, a peer device or other common network node, and typically includes many or all of the elements described relative to the computer 1702, although, for purposes of brevity, only a memory/storage device 1750 is illustrated. The logical connections depicted include wired/wireless connectivity to a local area network (LAN) 1752 and/or larger networks, for example, a wide area network (WAN) 1754. Such LAN and WAN networking environments are commonplace in offices and companies, and facilitate enterprise-wide computer networks, such as intranets, all of which may connect to a global communications network, for example, the Internet.

When used in a LAN networking environment, the computer 1702 is connected to the local network 1752 through a wired and/or wireless communication network interface or adapter 1756. The adaptor 1756 may facilitate wired or wireless communication to the LAN 1752, which may also include a wireless access point disposed thereon for communicating with the wireless adaptor 1756.

When used in a WAN networking environment, the computer 1702 can include a modem 1758, or is connected to a communications server on the WAN 1754, or has other means for establishing communications over the WAN 1754, such as by way of the Internet. The modem 1758, which can be internal or external and a wired or wireless device, is connected to the system bus 1708 via the serial port interface 1742. In a networked environment, program modules depicted relative to the computer 1702, or portions thereof, can be stored in the remote memory/storage device 1750. It will be appreciated that the network connections shown are exemplary and other means of establishing a communications link between the computers can be used.

The computer 1702 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

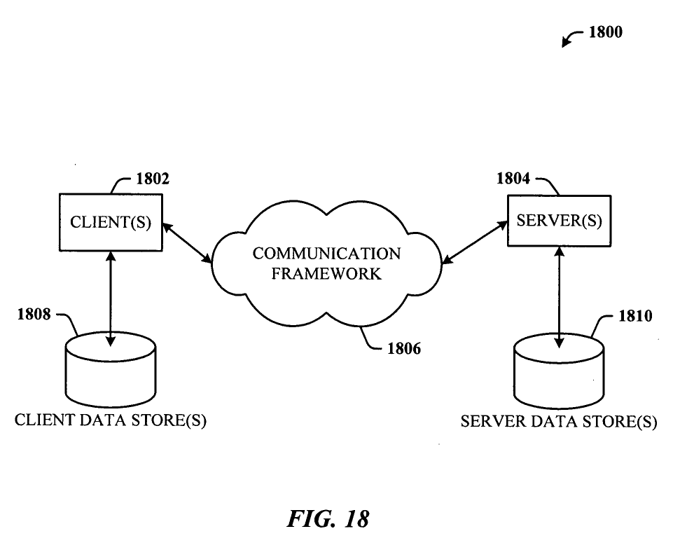

Referring now to FIG. 18, there is illustrated a schematic block diagram of an exemplary computing environment 1800 for defect recording and vendor web site processing in accordance with the innovation. The system 1800 includes one or more client(s) 1802. The client(s) 1802 can be hardware and/or software (e.g., threads, processes, computing devices). The client(s) 1802 can house cookie(s) and/or associated contextual information by employing the subject innovation, for example.

The system 1800 also includes one or more server(s) 1804. The server(s) 1804 can also be hardware and/or software (e.g., threads, processes, computing devices). The servers 1804 can house threads to perform transformations by employing the architecture, for example. One possible communication between a client 1802 and a server 1804 can be in the form of a data packet adapted to be transmitted between two or more computer processes. The data packet may include a cookie and/or associated contextual information, for example. The system 1800 includes a communication framework 1806 (e.g., a global communication network such as the Internet) that can be employed to facilitate communications between the client(s) 1802 and the server(s) 1804.

Communications can be facilitated via a wired (including optical fiber) and/or wireless technology. The client(s) 1802 are operatively connected to one or more client data store(s) 1808 that can be employed to store information local to the client(s) 1802 (e.g., cookie(s) and/or associated contextual information). Similarly, the server(s) 1804 are operatively connected to one or more server data store(s) 1810 that can be employed to store information local to the servers 1804.

The clients 1802 can include the monitor (optionally) and reporting components (202 and 206) for recording application events and defect information, and sending the record file and/or report to a web site, or one or more of the servers 1804.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates processing of application information, comprising:
a software component that generates a software defect as a part of software execution; and
a recorder component for recording the software defect in a record file.

2. The system of claim 1, wherein the record file is of a lightweight XML file format or a binary file format.

3. The system of claim 1, wherein the recorder component facilitates recording of a software event proximate to generation of the software defect.

4. The system of claim 1, further comprising a reporting component for generating a report that includes the record file, the reporting component interacting with the recorder component to include the record file in the report.

5. The system of claim 4, wherein the reporting component sends the report that includes defect information associated with the software defect of the application and events associated with causing the defect information.

6. The system of claim 1, wherein the recorder component facilitates manual entry of defect information recorded in the record file into a web site bug reporting page or an offline reporting template of an offline client.

7. The system of claim 1, wherein the recorder component facilitates conversion of the record file into a human-readable format.

8. The system of claim 1, wherein the recorder component facilitates creation of a script for regression testing of the software component.

9. The system of claim 1, wherein the record file is transmitted to a debug web site for resolution of the software defect.

10. The system of claim 1, wherein the recorder component facilitates recording of one or more of image data and snapshot data into the record file.

11. A computer-implemented method of processing application information, comprising:
running an application until defect information occurs;
activating a recorder to record the defect information;
rerunning the application until the defect information is recorded; and
storing the defect information in a record file.

12. The method of claim 11, further comprising automatically recording application event information prior to occurrence of the defect information and at the occurrence of the defect information and, storing the application event information and the defect information in the record file.

13. The method of claim 12, further comprising automatically inputting the defect information and the application event information into a report, and transmitting the report to a debug tool for playback.

14. The method of claim 11, further comprising rerunning the application to automatically record application steps prior to occurrence of the defect information and, storing the application steps and the defect information in the record file.

15. The method of claim 14, further comprising automatically recording screenshots in association with one or more of the application steps and, storing the steps, screenshots, and the defect information in the record file.

16. The method of claim 15, further comprising playing back the record file for conversion of file parts into a human readable file format.

17. The method of claim 11, further comprising integrating functionality of the recorder into the application, which application is a beta test application, for automatic recording and reporting of the defect information.

18. The method of claim 11, further comprising a test script for regression testing of the application based on the defect information.

19. The method of claim 11, further comprising manually triggering activation of the recorder for recording the defect information and application information associated with steps that lead up to creation of the defect information.

20. A computer-implemented system, comprising:
computer-implemented means for running an application of a client until a defect occurs;
computer-implemented means for activating a recorder;
computer-implemented means for rerunning the application and recording application reproduce steps leading up to reoccurrence of the defect and the defect in a record; and
computer-implemented means for playing back the record for automatic input of the reproduce steps and defect into a bug report in a human readable format.
